(19) United States
(12) Patent Application Publication
(10) Pub. No.: US 2004/0039734 A1
(43) Pub. Date: Feb. 26, 2004

(54) Apparatus and method for region sensitive dynamically configurable document relevance ranking

(76) Inventors: Douglass Russell Judd, Burlingame, CA (US); Ram Subbaroyan, San Francisco, CA (US); Bruce D. Karsh, Half Moon Bay, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/439,339

(22) Filed: May 14, 2003

Related U.S. Application Data
(60) Provisional application No. 60/380,763, filed on May 14, 2002.

(51) Int. Cl. G06F 7/00

(52) U.S. Cl. 707/3

(57) ABSTRACT

A document section sensitive relevance ranking system for ranking the results of a free-text search as part of a document indexing and document query system is disclosed. The system has a document indexer that accepts structured, semi-structured, or unstructured documents and creates an easily searchable index of the documents. Then, a document query system receives free-text queries, executes the query against the document index, and creates a list of result documents. The configurable relevance ranking system then ranks the individual documents in the document result list into an order of estimated relevance.

### CROSS REFERENCE TO RELATED APPLICATIONS

This application claims the benefit of U.S. Provisional Patent Application No. 60/380,763, filed May 14, 2002, entitled “Search and Retrieval System For Structured And Unstructured Content.”

This application is related to U.S. Ser No. ______, filed May 14, 2003, entitled “Apparatus and Method for Searching and Retrieving Structured, Semi-Structured and Unstructured Content,” which is assigned to the assignee of the present invention and which is incorporated herein by reference.

### FIELD OF THE INVENTION

Generally, the invention relates to the field of data storage and retrieval. More particularly, the invention relates to a document region sensitive configurable relevance ranking system that may be used with a semi-structured text search engine.

### BACKGROUND OF THE INVENTION

A database is a large collection of stored information. To retrieve a particular piece of information from a database, a database query is created and provided to the database. The normal database query is well defined. Specifically, normal database queries set forth a set of parameters that define exactly what is sought and if a record (or field) meets the well-defined query parameters then that record (or field) is returned. If no record (or field) meets the well-defined query parameters then a null result is returned.

Free-text queries (also known as full-text queries) generally operate in a very different manner. In a free-text query, a user enters a set of search terms (text) that the user believes describe or are located within the desired document, record, or file. The free-text query system then searches through the documents, records, or files in its database in attempts to find the documents, records, or files that best match the search terms entered by the user. In one typical embodiment, the free-text query system will locate all the documents, records, or files that contain one or more of the search terms entered by the user in the free-text query.

The results returned by a free-text query often contains far more documents, records, or files than the user wishes to closely examine. Thus, many free-text query systems also provide relevance ranking systems to help the user parse the free-text query results.

A relevance ranking system assigns a quantitative relevance value to each document in the free-text query results. The documents, records, or files in the free-text query results are then presented to the user starting with the document, record, or file calculated to be the most relevant and proceeding to the document, record, or file calculated least relevant. In this manner, the user is likely to quickly find the desired document, record, or file.

Relevance ranking systems generally help users locate a desired document. However, relevance ranking systems may not always work to the user's advantage. For example, a user wishing to locate documents on a specific Kurt Vonnegut book may enter “Breakfast of Champions” into a free-text query system. Upon returning the results, the relevance ranking system may list a number of documents about the General Mills Cereal “Wheaties” at the top of the list since that product is often referred to by its nickname “The Breakfast of Champions”.

To obtain more relevant results (i.e., results about the Kurt Vonnegut book) for specific applications, some users may wish to “tune” the methods used by a relevance ranking system in order to obtain more desirable results. For example, in the preceding example, the user may wish to have documents that contain the matching search terms (“Breakfast of Champions”) in a title location ranked higher than documents that only have the matching search terms in the body of the work. Thus, it would be desirable to have a runtime configurable relevance ranking system.

### SUMMARY OF THE INVENTION

The present invention discloses a configurable relevance ranking system for ranking the results of a free-text search. The configurable relevance ranking system operates as part of a document indexing and document query system. Specifically, a document indexer accepts structured, semi-structured, or unstructured documents and creates an easily searchable index of the documents. The document query system receives free-text queries, executes the query against the document index, and creates a resultant list of documents. The configurable relevance ranking system then ranks the individual documents in the resultant list of documents such that the resultant list of documents is placed into order of estimated relevance.

The configurable relevance ranking system operates by first reading in a configurable set of relevance ranking parameters. In one embodiment, the relevance ranking parameters allow an administrator to create scoring regions within documents and adjusted weight sections within documents. The scoring regions define sections of a document that are individually relevance scored in a defined manner. The adjusted weight sections define regions of a document where in search term matches are weighted differently. After reading in the relevance ranking parameters, the configurable relevance ranking system may then create a set of data structures that allow optimized relevance score calculation.

The relevance ranking system then scores the documents within the resultant list of documents from the document query system. Specifically, the relevance ranking system applies a specific set of relevance ranking heuristics to the resultant list of documents using the administrator configured relevance ranking parameters to generate a relevance score for each document. The resultant list of documents is then ordered using the document relevance scores.

Other objects, features, and advantages of present invention will be apparent from the drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a block diagram of a document indexing and query response system configured in accordance with an embodiment of the invention.

FIG. 2 illustrates a tree structure created from the free-text query “(Superman OR Batman) AND (Playstation2 OR PS2)”.

FIG. 3 illustrates one embodiment of a document indexing structure that may be used in accordance with an embodiment of the invention.

FIG. 4 illustrates an example XML document that has some of its words indexed in the document index structure of FIG. 3.

FIG. 5 illustrates a flow diagram that sets forth an embodiment of the invention.

FIG. 6A illustrates a one-dimensional array that is indexed by word location and specifies a scoring region code in accordance with an embodiment of the invention.

FIG. 6B illustrates a one-dimensional array that is indexed by word location and specifies a weight region code in accordance with an embodiment of the invention.

FIG. 7 illustrates a flow diagram that sets forth an alternate embodiment of the invention.

### DETAILED DESCRIPTION OF THE PREFERRED EMBODIMENT

A document region sensitive configurable relevance ranking system is disclosed. In the following description, for purposes of explanation, specific nomenclature is set forth to provide a thorough understanding of the present invention. However, it will be apparent to one skilled in the art that these specific details are not required in order to practice the present invention. For example, the present invention has been described with reference to a free-text query response system aided by a word index. However, techniques and teachings of the present invention can easily be applied to free-text query systems with other types of indexing systems or with no indexing systems at all.

The teachings of the present invention may be implemented with a set of computer instructions that perform the described methods. As is well known in the art, the computer instructions may be stored on a computer readable media such as a magnetic disk, magnetic tape, optical media, or any other computer readable form such that the instructions may be transported or archived.

A free-text query system allows a user to locate a desired document or record by entering text terms that will likely be found within or describe the document or record. When a free-text query system returns the results of a search, the free-text query system may use a relevance ranking system for the benefit of the user that requested the search. The relevance ranking system attempts to rank the probable relevance of the documents or records in the full results of the search.

A relevance ranking system does not actually know exactly what the user is seeking. Thus, most relevance ranking systems use various heuristics to determine what is more likely to be relevant to the user. For example, documents with a high number of matching search terms are generally ranked higher than those that do not match all the search terms. Similarly, documents that have the desired search terms in the same order entered in by the user are generally ranked higher than documents that have the terms in a different order. These heuristics are statically coded into the relevance ranking system and cannot be changed.

To provide better relevance rankings, the present invention introduces a runtime configurable relevance ranking system. With the configurable relevance ranking system of the present invention, an administrator may tune the relevance ranking system such that the relevance ranking system operates in a manner best suited for a particular application. For example, an email application may be improved if search term matches found in the subject of an email message are ranked much higher than search term matches found in the body of the email message.

A relational database is an example of structured data. In a relational database, the data is stored in tables wherein each table comprises a number of entries. Each table has predefined columns or fields that specify the type of data stored in that column for each table entry (or row). Fields in one table may refer (or relate) to an entry in another table, hence the term “relational” database. The complex organization of tables, the fields within table entries, and the relations between tables is referred to as the database “schema.”

Although structured data stored in relational databases provides an efficient means for organizing and searching data in some applications, databases are very rigid because all data must be placed in predefined data fields. Furthermore, structured databases require difficult planning and deployment steps. For example, a database schema must be defined, user interfaces must be created, database queries must be written, etc.

Instead of creating a full database, many people improvise simple databases using a common text editor or a word processor. For example, a simple text file containing a list of names and telephone numbers can be considered a simple database. The manner in which the user organizes their text file determines if the text file database is unstructured text, semi-structured text, or structured text.

If the user haphazardly puts in names and numbers without any order and includes other information such as addresses mixed in, the text file database is unstructured text. There is no discernable structure to the text file that can be exploited.

If the user always rigidly organizes the names and numbers exactly the same way into a specific format, then the user's text file database is a “structured text” database. For example, if each and every line of the text document is organized as “first_name last_name phone_number” then the text document is a structured text document. With such a structured text document, an application can use the known file structure for navigation, searching, importing, exporting, or other data manipulations.

If the user does not rigidly organize document but does follow certain patterns such that information can always be extracted using a well-defined rule, then the text database is a “semi-structured text” database. For example, a semi-structured text document may place “name:” before each name and “phone:” before each phone number such that the names and telephone numbers can easily be extracted from the document but the document also contains other information such as notes about the various people. In such an embodiment, the rules of “select the text after the string ‘name:’ as a name” and select the text after the string ‘phone:’ as a phone number” allow a parsing system to extract names and phone numbers out of the semi-structured text file even though it may contain other regions of unstructured text.

The configurable relevance ranking system of the present invention can be used with unstructured text documents, semi-structured text documents, or structured text documents. When configurable relevance ranking system is used with unstructured text, it is not able to adjust its ranking system based up on the specific text regions. However, when the configurable relevance ranking system is used with semi-structured or structured text documents, the configurable relevance ranking system takes advantage of the available document structure. For example, the configurable relevance ranking system of the present invention can be configured to identify specific regions within semi-structured or structured text documents and adjust its relevance ranking behavior for the identified regions. In this manner, the combination of semi-structured or structured text documents and an associated specifically configured relevance ranking system can be used to quickly locate specific documents or specific information within these documents.

In one embodiment, semi-structured or structured text documents may be created using the industry standard extensible Markup Language (XML). XML documents are text documents that use a well-known markup language tagging for a specific purpose. Detailed information about XML can be found at the web site http://www.w3.org/XML/.

Due to the extensive amount of software for creating, editing, and parsing XML documents and its simple yet powerful nature, XML has become a lingua franca of Internet commerce. XML documents have been used to represent everything from purchase orders to medical records. Although the present invention is disclosed with reference to XML format for semi-structured and structured data, the teachings of the present invention could easily be applied to other semi-structured or structured text data formats.

The configurable relevance ranking system will be disclosed with reference to one embodiment of a document indexing system. However, it should be noted that teachings of the present invention might just as easily be practiced with other document indexing system implementations or with a system without any indexing system. The use of an indexing system greatly improves the response time when performing free-text queries.

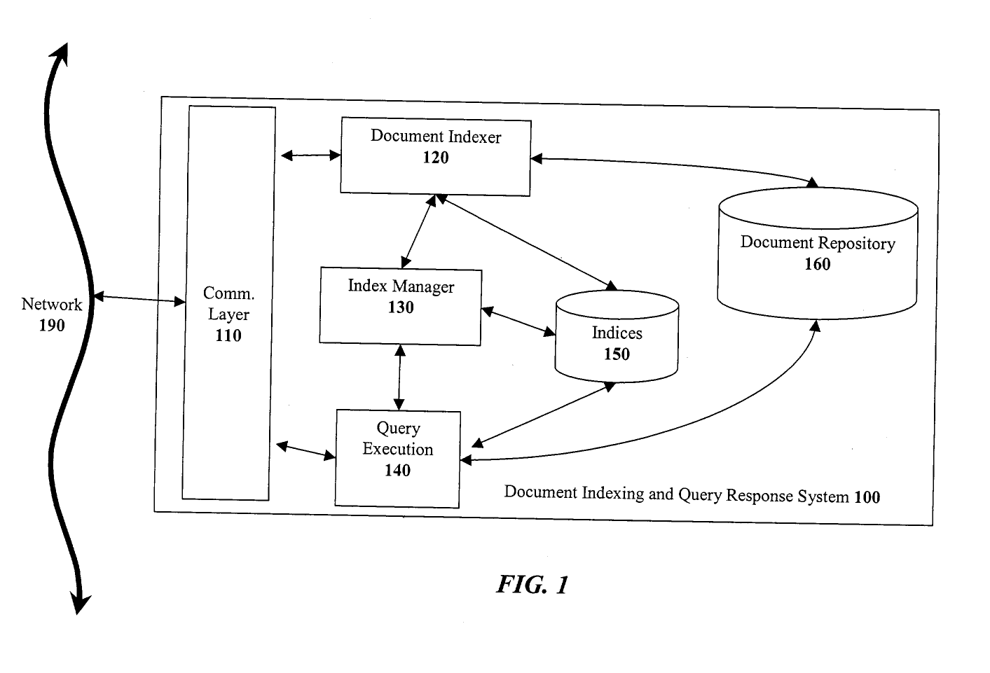

FIG. 1 illustrates one embodiment of a document indexing and query response system 100. The document indexing and query response system 100 serves two main purposes: (1) It accepts new documents from outside sources and adds those new documents to the index with the document indexer 120; and (2) It responds to query requests with query execution module 140. (In one embodiment, the document indexing and query response system 100 may also serve the documents specified in a query.)

To communicate with other entities, the document indexing and query response system 100 has a communication layer 110. In the embodiment of FIG. 1, the communication layer 110 is coupled to a computer network 190 such that the document indexing and query response system 100 may receive new documents and query requests from other entities coupled to the computer network 190.

The document indexer 120 is responsible for accepting new documents into the document indexing and query response system 100. When the document indexer 120 receives a new document to index, the document indexer 120 first assigns a unique identifier to the new document.

Next, the document indexer 120 obtains an available index from the index manager 130. The index manager 130 selects an index from the collection of indices 150 and provides the index to the document indexer. The document indexer 120 then generates an index of the received document and stores the information in the index received from the index manager 130. Detailed information on one index embodiment will be provided in a later section of this document.

After indexing the document, the modified index is returned to the index manager 130. Finally, in one embodiment, the document indexer 120 stores a modified version of the document in the document repository 160. In versions without a document repository, the documents may be stored on a normal file server.

After the document indexer 120 has indexed a number of documents, the document indexing and query response system 100 may begin servicing query requests. The document indexing and query response system 100 may receive query requests through the network 190. The communication layer 110 of the document indexing and query response system 100 routes query requests to a query execution module 140.

In one embodiment, the query execution module 140 receives queries formatted in the XML Query language (also known as “XQuery”). Detailed information about XQuery can be found at the World Wide Web Consortium (W3C) web site at http://www.w3.org/XML/Query. The query execution module 140 first parses the received XQuery. If the XQuery does not include a free-text search, then the query execution module 140 simply responds to the query and there is no need for any relevance ranking.

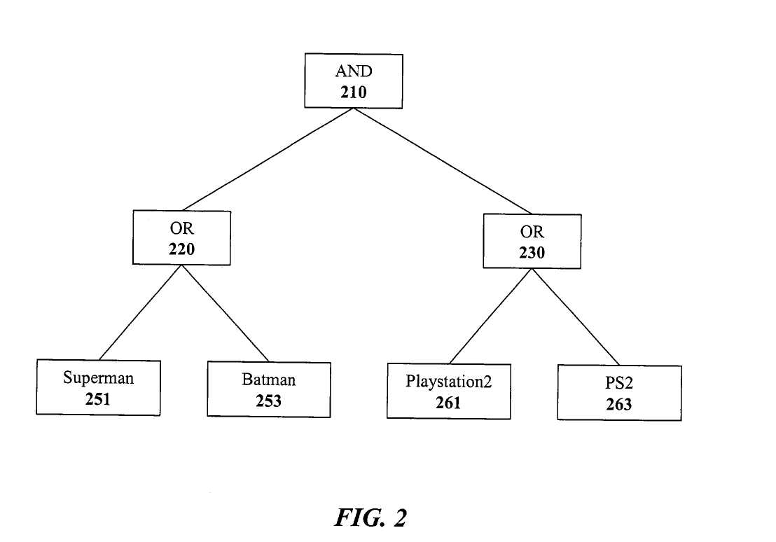

When an XQuery includes a free-text search string for a free-text query, the query execution module 140 then parses the free-text search string. In one embodiment, the query execution module 140 creates a tree structure from the free-text search string. For example, the query execution module 140 would parse the free-text search string “(Superman OR Batman) AND (Playstation2 OR PS2)” to create the parsed tree structure illustrated in FIG. 2.

After parsing the free-text search string, the query execution module 140 applies the free-text query to the indexed documents. To begin the query, the query execution module 140 first requests one or more “iterator” objects from the Index Manager 130. An iterator object is used to navigate through indices in the index collection 150. The index manager responds to the iterator request by providing the iterator object to the query execution module 140 at an appropriate time. This technique allows the Index Manager 130 to arbitrate between requests to query and update the indices 150.

Referring back to FIG. 2, in one embodiment each node of the search tree is an object that handles part of the search request. Superman object 251, Batman object 253, Playstation2 object 261, and PS2 object 263 each locate documents that have the terms “Superman”, “Batman”, “Playstation2”, and “PS2” respectively. OR object 220 combines the search results of Superman object 251 and Batman object 253 with a Boolean “OR” operation. Similarly, OR object 230 combines the search results of Playstation2 object 261 and PS2 object 263 with a Boolean “OR” operation. Finally, AND object 210 combines the results of OR object 220 and OR object 230 with a Boolean “AND” operation to generate the final search results. The query execution module 140 returns the final search result back to the entity that requested the query.

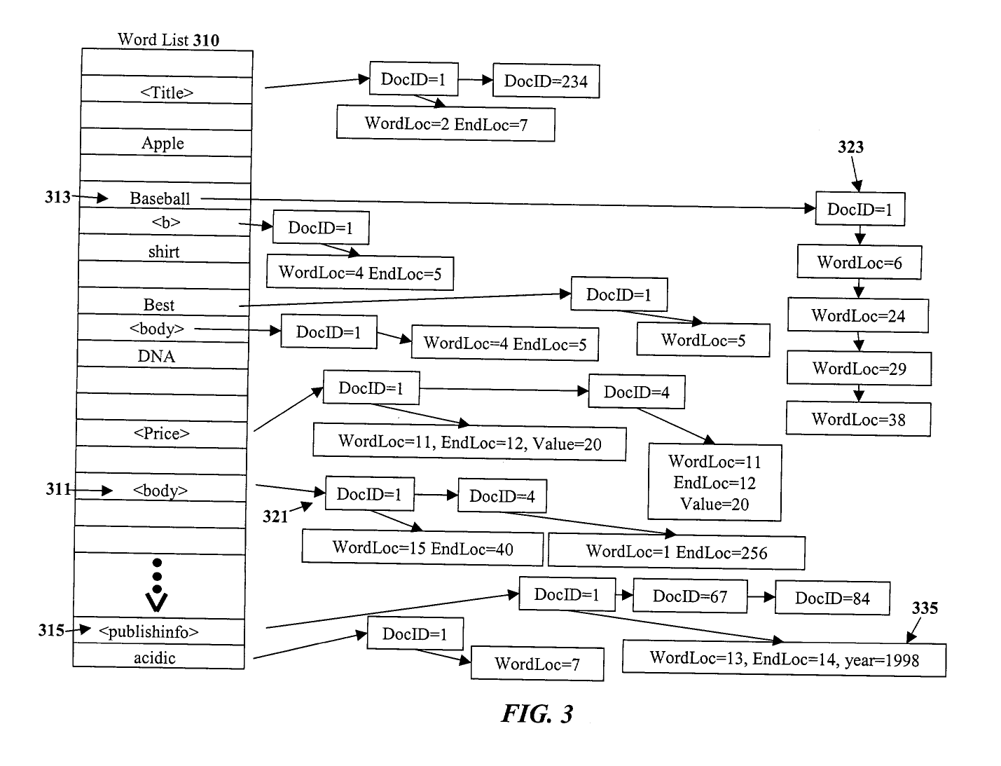

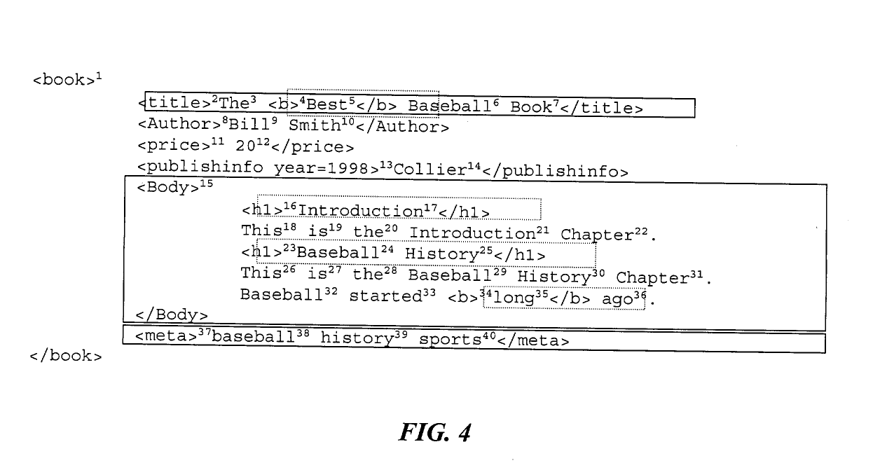

To efficiently search the documents for particular text items (words or other alphanumeric text structures), the document indexing and query response system 100 builds indices 150. FIG. 3 illustrates one possible embodiment of an index structure. The index structure of FIG. 3 will be described with reference to an XML document illustrated in FIG. 4.

In the embodiment of FIG. 3, the indexing system divides each document into a list of its individual words and XML tags. Referring to FIG. 4, each word and XML tag is then given a sequential number as shown by the superscripted number. For example, the XML tag “<book>” is assigned word location “1” and the first word of the title “The” is assigned word location 3. The numbered locations of all the words and XML tags are then recorded in the index structure illustrated in FIG. 3.

Referring to the left side of FIG. 3, the indexing system creates a unique word list 310 that has an entry for each unique word found in the indexed documents. (In a preferred embodiment, the word list does not store the actual word but a hashed version of the word. However, FIG. 3 illustrates the actual word in order to simplify the explanation.)

Associated with each word in the unique word list 310, is a list of documents that contain that word. For example, the XML document of FIG. 4 includes an XML tag “<body>”. Thus, the unique word list 310 includes an entry 311 for “<body>”. Each unique word entry has an associated list of documents that contain that unique word. The document illustrated in FIG. 4 shall be referred to as the document with document identifier number 1 (DocID=1). Since the document includes the tag “<body>”, the unique word list 310 that has a unique word <body> entry 311 that points to an associated document list that includes an entry 321 specifying “DocID=1” for the document of FIG. 4. (The associated document list for the unique word <body> entry 311 also includes another entry for another document, “DocID=4”.)

Referring to FIG. 3, each document entry in the associated document list for a unique word further contains a list of all the locations where that unique word appears in the document. As illustrated in FIG. 4, the <body> tag is the fifteenth text item in the document. Thus, the word location list associated with DocID=1 contains a word location entry that specifies WordLoc=15 to indicate that <body> is located at the fifteenth (“15”) word location. In the document of FIG. 4, the word location of each word is given as a superscript after each word.

For eXtended Markup Language (XML) tags, the word location entry in the index of FIG. 3 also specifies where the related “closing” tag is located. In this case, the closing tag is </book> and the location of that closing tag is specified with the term EndLoc=40. Normal Text words have no related “closing” tags such that only a word location is provided. For example, the unique word entry 313 “Baseball” has four associated word location entries that specify the location of the word “Baseball” at word locations 6, 24, 29, and 38.

Certain words or tags may have additional information stored in the index system. For example, tags that have associated values may have those values stored in the index. Referring to FIG. 4, the <book> document includes the tag <publishinfo> as the 13^{th} word. The <publishinfo> tag includes an attribute of “year” that is set to 1998 (year=1998). In one embodiment of the present invention, the word location entries in the unique word list 310 also specify such attribute values. Thus, the word location entry 335 associated with document 1 for the unique <publishinfo> word 315 specifies that the year attribute is 1998 (year=1998).

Relevance ranking operates by analyzing the documents that have matching terms after execution of a free-text query and judging the “quality” of those matches using certain assumptions. These assumptions are used to create a set of heuristics for judging match quality. The following list consists of a number of heuristics that may be used for judging search term match quality:

Documents containing many matching search terms are ranked higher than documents with fewer matching search terns;

Documents that have the matching search terms in close proximity are ranked higher than documents that have matching search terms located far from each other;

Documents containing a greater number of search term matches are ranked higher than documents with fewer search term matches; and

Documents that have search term matches of rare search terms in the search query are ranked higher than documents that only match common search terms.

Other relevance ranking heuristics may also be applied. Furthermore, an embodiment of the present invention does not need to implement all of the heuristics listed above.

In one embodiment of the present invention, the relevance ranking system creates relevance scores for different “regions” of a document and then combines those regional relevance scores to generate an overall document relevance score. For example, a typical Hyper-Text Markup Language (HTML) document contains a title region and a body region. Individual relevance scores may be separately calculated for the title region and the body region. The title region relevance score and the body region relevance score may be subsequently combined to generate an overall relevance score for the document.

The overall relevance score for a document may be computed by summing together the relevance ranking scores for the different regions. Alternatively, the overall relevance score for a document may simply be set to the largest score found for all the different regions of the document. In one preferred embodiment, the individual regional relevance scores are averaged together in order to prevent one region of the document from dominating the other regions of the document. Furthermore, a region influence limit parameter may limit the amount of influence any particular document region may affect the overall document relevance score.

To score the different regions of a document, one embodiment of the present invention analyzes various different quantitative measures of the search term matches found within the region. In one embodiment, the matching term proximity and the matching term frequency are quantified for use in calculating the relevance score of the document region.

The relevance ranking system generates a proximity score that is correlated to the distance between the matching search terms. The closer the matching search terms are to each other, the higher the proximity score. Thus, if a user enters the search string “tom cruise” then the relevance ranking system will rank documents with the name of the actor Tom Cruise higher than a document containing the sentence “Tom asked the automobile salesman if the automobile was equipped with a cruise control system.”

In one embodiment, the relevance ranking system generates a proximity score by calculating a harmonic mean of the distances between adjacent matching terms. For example, if a free-text query is searching for terms A, B, and C (a free-text query string of “A B C”) and the document text is “x A x x x B x x C x x x x x x A x x” (where each “x” represents a word), then the harmonic mean is calculated as the distance between the first A & B (a word distance of 4), the distance between B & C (a word distance of 3), and the distance between C & the last A (a word distance of 7). Thus

$$Harmonic mean = \frac{n}{\frac{1}{{a}_{1}} + \frac{1}{{a}_{2}} + … \frac{1}{{a}_{n}}} = \frac{3}{\frac{1}{4} + \frac{1}{3} + \frac{1}{7}} = 4.131$$

The harmonic mean has the useful property that one large value does not disproportionally affect the calculated mean value

The proximity score generation may be modified using various adjustments. For example, if two consecutive search terms are not in the same order as the original free-text query, then a penalty amount may be added to the distance between the two adjacent terms. Furthermore, there may be a “drop gap” distance. The drop gap distance is the maximum distance allowed between “adjacent” search terms. If the drop gap distance is exceeded, then a new adjacent pair distance will begin starting with the next matching search term encountered.

The presence or absence of terms may be used to affect the relevance score. In one embodiment, the presence or absence of terms is used to modify the proximity score. In such an embodiment if there are n terms in the free-text query and m of the n terms are found in the document, then the proximity score may be multiplied by

$$\frac{m - 1}{n - 1}$$

in order to reduce the proximity score if all of the terms are not found in the n−1 document. For example, if the free-text query has the four search terms A, B, C, and D (a free-text query string of “A B C D”) and the document only contains terms AB and BC, t h e n the proximity score is multiplied by a value of

$$\frac{m - 1}{n - 1} = \frac{3 - 1}{4 - 1} = \frac{2}{3} .$$

The number of times a particular search term appears in a document (the search term's “frequency”) also helps determine its relevance. In one embodiment, the relevance ranking system calculates two different types of frequency for each search term: absolute frequency and relative frequency. The absolute frequency (FA) of a search term is the number of times that the search term appears in a particular region. The relative frequency of a search term is the number of times that the search term appears in a particular region divided by the length of the region (L). Thus, the relative frequency can be expressed in terms of the absolute frequency (FA) and the length of the region (L) as follows:

$$relative frequency = \frac{{F}_{A}}{L}$$

Where

F_{A}=the absolute frequency.

L=the length (in words) of the region.

The absolute frequency for a search term in a document region and relative frequency for the search term in the document region may be combined to calculate a normalized frequency for the search term in the document region. In one embodiment, constants are used to combine the absolute frequency and relative frequency into a normalized frequency. Specifically, the normalized frequency can be expressed as follows:

$$normalized frequency = {F}_{N} = {K}_{A} {F}_{A} + {K}_{R} \frac{{F}_{A}}{L}$$

Where

K_{A}=specifies a constant multiplier (in the range of 0 to 1) for the absolute frequency.

F_{A}=the absolute frequency.

K_{R} a constant multiplier (in the range of 0 to 1) for the relative frequency.

L=the length (in words) of the region.

Next, the normalized frequency values for each region of the document may be combined for an overall normalized frequency for the document. However, the frequency values from one region may drown out the frequency values for another region. Thus, one embodiment limits the amount of effect each region may have on the combined normalized frequency.

Finally, the system may combine the normalized frequencies for the different search terms into a refined score for the document. The refined score may take into account how rare a particular search term is such that documents that contain a rare search term are given a higher score. One embodiment performs this by calculating an inverse document frequency (IDF) score for each search term that specifies the rarity of the search term. The IDF score of a search term is used to adjust the refined score. The IDF score is calculated by taking the logarithm of the number of documents that contain the search term divided by the total number of indexed documents (D). The refined score may also take into account the number of search terms that are matched. In one embodiment this is performed by adding a scaled value of the number matches into the refined score.

In one embodiment, the refined score is calculated as follows:

$$refined score = RS = \frac{1}{M} {\sum }_{i = 1}^{M} [ ln ( {F}_{N} ) - {K}_{IDF} * \overbrace{ln ( \frac{{W}_{i}}{D} )}^{IDF} ] + {K}_{matching} M$$

Where

M=the number of matching terms in this particular document.

F_{M}=Normalized frequency.

Wᵢ=the number of documents that match the current search term i.

D=the total number of documents in the document repository.

K_{IDF}=a multiplier used to adjust how much the inverse document

frequency (IDF) of the word should increase the refined score.

K_{matching}=a multiplier to adjust how the number of matching documents.

Note that if the K_{matching} multiplier is sufficiently large, the returned documents sorted by relevance score will be divided into bands of documents depending on the number of search terms matched. Specifically, a first band of documents will contain documents that match all the search terms, a second band of documents will contain documents that match all but one of the search terms, and so on.

The relevance ranking system generates an overall relevance score for a document by combining the proximity score and the refined score. In one embodiment, the proximity score is added to the refined score to generate a final document relevance score.

The present invention introduces a configurable relevance ranking system. The configurable relevance ranking system allows a person to configure a relevance ranking system in a specific manner that will allow the relevance ranking system to be adapted for a particular application. The configurable relevance ranking system may provide a number of different ways to adjust the relevance ranking. In one embodiment, two important configurable concepts are (1) “free-text scoring regions” within documents; and (2) “adjusted weight section” within documents.

As set forth in the previous section, a relevance ranking system may divide a structured document into distinct individual regions. For example, a Hyper-Text Markup Language (HTML) document may be divided into Title, Body, and Meta-description regions. The present invention allows these different regions to be scored individually and in different manners by creating free-text scoring regions. Relevance scores for these three different free-text scoring regions are individually calculated and then combined. With the configurable relevance ranking system of the present invention, an administrator can define a set of scoring regions and set various parameters that define how the newly created scoring regions are scored. In addition to the individually defined free-text scoring regions, a default scoring region may also be defined. The default scoring region encompasses the full document such that any document region that does not fall within an individually defined scoring region is scored using the parameters of the default scoring region.

Adjusted weight sections are further used to control the relevance scoring system. Adjusted weight sections are sections of text that are treated differently than other text within the same scoring region. For example, an administrator may define sections of bold text as sections that are given more weight during scoring. For example, matching text in a bold region may be scored as three times more important.

In one embodiment, the relevance ranking system allows an administrator to create a set of well-defined free-text scoring regions. The administrator may then specify how relevance scores are calculated for these newly defined free-text scoring regions. In one embodiment, the administrator simply specifies a set of relevance scoring parameters.

Every document may also be assigned a default scoring region that spans the entire document. The default scoring region has its own set of relevance calculating parameters. Any text not falling within one of the administrator-defined free-text scoring regions has its relevance calculated using the relevance scoring parameters of the default scoring region.

The created scoring regions affect the document relevance ranking calculations. When relevance ranking is performed, the relevance ranking system computes a relevance score for administrator defined scoring regions and for the default scoring regions (if default scoring regions are defined). These individually calculated scoring region relevance scores are then combined together to create an overall relevance score for the document. In one embodiment, the individual scoring region relevance scores are combined by taking the logarithm of cumulative scores for all the administrator defined regions (including the default scoring region if a default scoring region is defined).

In the configurable relevance ranking system of the present invention, an administrator defines a custom scoring-region by first identifying the schema or type of document that the scoring region applies to and then setting the values of parameters that define the scoring region. In one embodiment, an administrator defines four parameters for each new scoring region: query, match_weight, absFreqCoeff, and maxContribPct. Other implementations may use additional or fewer relevance scoring parameters. These attributes and parameters may be set in a configuration file that is loaded by the document indexing and query response system 100. The following table lists illustrative syntax for defining a new scoring region.

TABLE 1
Scoring Region Definition

/xdb/query/scoring/n/param string doc-class scoring-region
/xdb/query/scoring/n/query string query
/xdb/query/scoring/n/weight float weight
/xdb/query/scoring/n/absFreqCoeff float coeff
/xdb/query/scoring/n/maxContribPct float pct

Each entry in the scoring region definition will be described in detail. Note: the path component, n, just after the scoring path component, is the scoring configuration number. This scoring configuration number identifies the position of each set of scoring configuration settings in the list of all scoring configurations in the server configuration file. The scoring configuration numbers must start at 1 and be incremented by 1 for each set of scoring configuration settings in the server configuration file.

An administrator first specifies the schema or type of document to which the new scoring-region will apply. In one embodiment, the administrator specifies this by setting the value of doc-class to the name of the top-level element of a document class. For example, an administrator may create a scoring region for <book> type documents such as the document illustrated in FIG. 4 by specifying a doc-class of “book” as follows:

/xdb/query/scoring/n/param string book scoring-region

In this manner, this scoring region will only apply to <book> class documents. Thus, different relevance ranking systems can be independently created for different types of documents. The value of the scoring configuration number, n, set for this scoring-region is the value that must also be set for n in the four configuration lines that follow in the server configuration file.

The administrator then specifically defines the region within the document where the customized scoring algorithm will be applied. In one embodiment, the scoring region is specifically defined by an XML path language (Xpath) expression that must evaluate to a node set. Xpath is a language for addressing parts of an XML document. Detailed information about Xpath can be found at the world wide web site http://www.w3.org/TRixpath. For example, to define the “title” of the book in FIG. 4 as a scoring region, the administrator would use the following configuration line:

/xdb/query/scoring/n/query string//title

The scoring region may be disjoint as would be the case when the query evaluates to more than one node in the document.

A newly defined scoring region may overlap with a previously defined scoring region, in which case it would split the previously defined scoring region into two or more parts. The innermost scoring region (e.g., the deepest node in the Document Object Module (DOM) tree) takes precedence.

The administrator defines a weight parameter to specify the importance of matches within the scoring region. Specifically, the weight attribute is the number that is added to the relevance score for each word or phrase match that occurs in the scoring region. In one embodiment, the default scoring region is assigned a weight of 1.0. If the weight value of a scoring region is 2.0, then a single word or phrase match in that scoring region would contribute the same amount to the relevance score as two matches from a scoring region with a weight of 1.0. To set the weight of a scoring region to 2.0, the administrator would use the following configuration line:

/xdb/query/scoring/n/weight float 2.0

As set forth in the previous section on relevance ranking, the relevance scoring system computes a scoring factor called the normalized frequency for each word or phrase in the free-text query. The normalized frequency is defined in terms of the absolute frequency (the number of times the word or phrase is encountered in the region) and the relative frequency (the number of times the word or phrase is encountered in the region normalized over the length of the region).

In one embodiment, the administrator may set the AbsFreqCoeff value to a number in the range of 0.0 and 1.0. This AbsFreqCoeff value determines how much the absolute frequency contributes to the overall normalized frequency. The relative frequency will be deemed to contribute the remainder, (1−AbsFreqCoeff). Thus, in one embodiment, the equation for normalized frequency appears as follows:

$$\begin{matrix}normalized frequency = {F}_{N} \\ = AbsFreqCoeff * {F}_{A} + ( 1 - AbsFreqCoeff ) {L}_{AVG} \frac{{F}_{A}}{L}\end{matrix}$$

where

F_{A}=the absolute frequency of the search term.

L_{AVG}=a constant that represents the average length of the scoring region across all documents.

L=the length of the region in words.

AbsFreqCoeff=the percentage that the absolute frequency contributes to the normalized frequency.

Setting AbsFreqCoeff to 1.0 causes the absolute frequency to contribute everything and the relative frequency to contribute nothing to the normalized frequency, while setting AbsFreqCoeff to 0.0 causes the absolute frequency to contribute nothing and the relative frequency to contribute everything. Setting AbsFreqCoeff to 0.5 would cause an equal contribution from both.

The maxContribPct parameter controls the maximum contribution that this scoring-region can make to the overall score. Having a maxContribPct parameter provides protection against intentional or inadvertent overused terms from strongly affecting the outcome. For example, an enterprising real estate agent may attempt to abuse the fact that title words in documents are given a higher weight during searches. Such an agent might put together a document about real estate that they have listed in Arizona, but inject the phrase “UNIX programming” 50 times in the title of the document. Later, when a hapless programmer is looking for information about UNIX programming, the first result that pops up in the result list is a document about real estate in Arizona. By limiting the maxContribPct value for the title region, the contribution of title region will not totally overwhelm other documents. Thus, the real estate document with the desired search term of “UNIX programming” in the title but not in the body of the document will not appear at the very top of the document list. The maxContribPct is a percentage from 1 to 100.

Sometimes a searcher may wish to have words that appear in certain elements or attributes of an XML document to make a higher contribution to the relevance score than words in the same region. For example, in an HTML document, an administrator may wish to have words that appear in sections of boldface text to count more towards the relevance score than words in normal text. The present invention allows an administrator to accomplish this goal by setting up an adjusted weight section for sections of boldface text.

In one embodiment, an administrator defines an adjusted weight section by specifying a document class, a scoring configuration number, and setting the values of two attributes for the adjusted weight section: query and weight. The administrator may set these values for the adjusted weight section and its attributes via three configuration lines in a server configuration file:

### Adjusted Weight Section Definition

/xdb/query/scoring/n/param string doc-class weight-region

/xdb/query/scoring/n/query string query

/xdb/query/scoring/n/weight float weight

The path component, n, just after the scoring path component, is the scoring configuration number. This scoring configuration number identifies the position of each set of scoring configuration settings in the list of all scoring configurations in the server configuration file. Note that the scoring configuration numbers must start at 1 and be incremented by 1 for each set of scoring configuration settings in the server configuration file.

To define an adjusted weight section, an administrator first defines the type or schema of documents to which the adjusted weight section will apply. Specifically, the administrator sets a doc-class to the name of the top-level element of the document class (e.g. html) that will be affected by the adjusted weight section. Only documents of the specified document class will be affected by the created adjusted weight section. Thus, the system of the present invention allows different adjusted weight sections to be created for different document types.

The administrator uses the query parameter to define the actual section within the document where the customized scoring weight will be applied. In one embodiment, the adjusted weight section is defined using an Xpath expression that must evaluate to a nodeset. The adjusted weight section may be disjoint as would be the case when the query evaluates to more than one node in the document. For example, the query //b would locate all the different disjoint sections of boldface text in an html document. The one adjusted weight section may overlap with a previously adjusted weight section, in which case it would split the previously defined region into two or more parts. The innermost region (e.g. deepest node in the Document Object Model (DOM) tree) takes precedence.

The weight attribute is the number that is added to the score when a word or phrase match occurs in the adjusted weight section. The default weight contributed by a match is determined by the weight specified for the scoring region in which the match occurs. In one embodiment, the relevance ranking system selects the larger of the adjusted weight or the weight specified for the scoring region. For example, referring to FIG. 4, if a <title> scoring region has been defined and a boldface (<b>) adjusted weight section has been defined, then when scoring a hit on the word “Best” (word 5) the relevance ranking system will select the larger of the weight parameter of the <title>scoring region or the adjusted weight for the boldface (<b>) adjusted weight section.

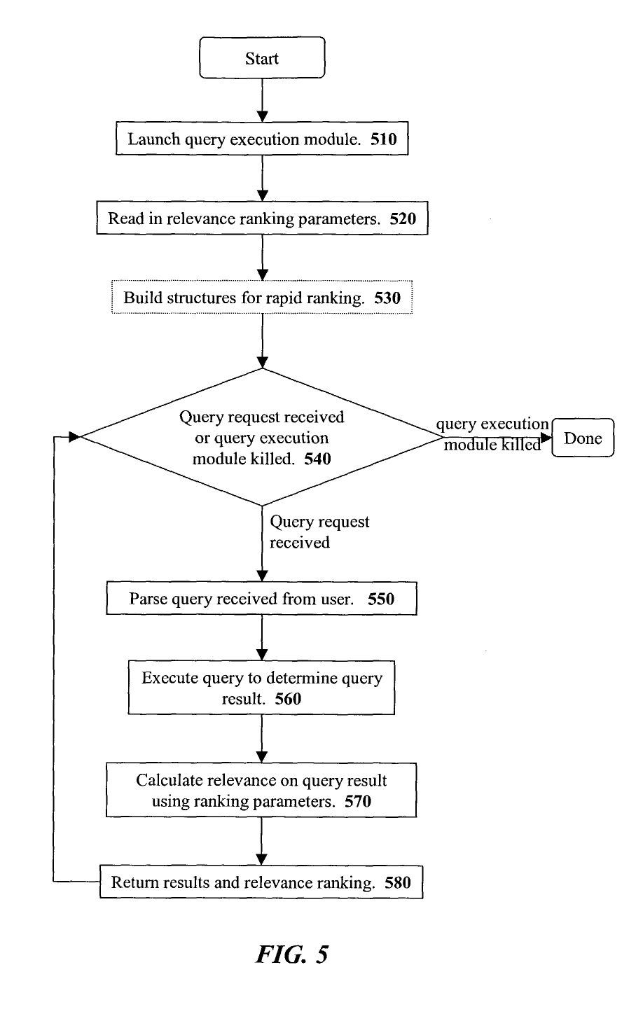

FIG. 5 illustrates a flow diagram that sets forth how one embodiment of the present invention operates. Referring to FIG. 5, the system first launches the query execution module 510. The query execution module then loads in the customized relevance ranking parameters 520. The previous section describes one embodiment wherein the customized relevance ranking parameters are stored in a configuration file. The query execution module loads those parameters.

At 530, the query execution module may create specialized structures that help perform relevance ranking quickly. In the embodiment described in this document, the query execution module uses Xpath nodesets to identify scoring regions and adjusted weight sections, but the indexing system uses word number locations to identify the locations of words and tags.

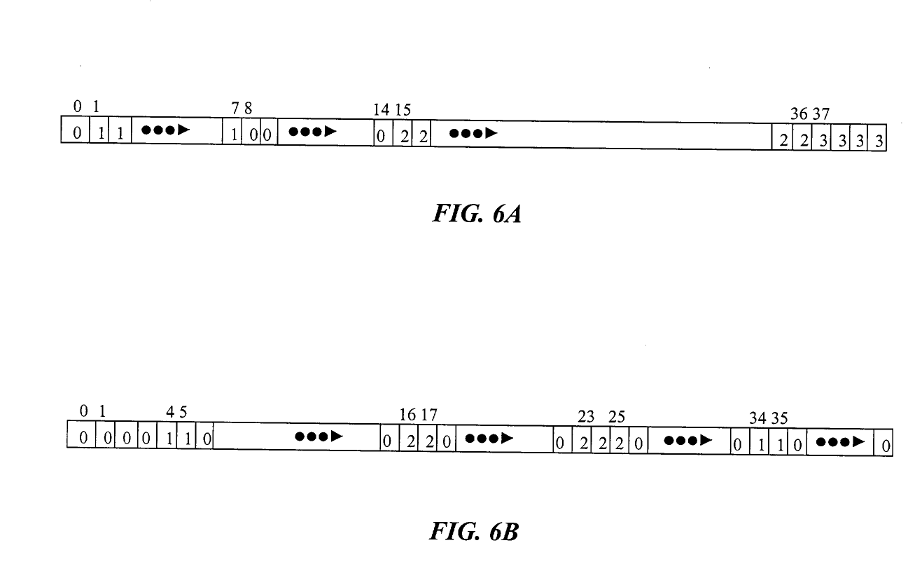

In one embodiment, the query execution module may create a pair of one-dimensional arrays by translating the nodeset defined scoring regions and adjusted weight sections into word locations. The one-dimensional arrays can then be used to quickly identify if a word falls within a scoring region or an adjusted weight section. Specifically, the pair of one-dimensional arrays are indexed by the word number and specify which scoring region or an adjusted weight section, respectively, the word falls within. For example, FIG. 6A illustrates a one-dimensional array that is indexed by word location and returns a “0” for a default scoring region, “1” for a <title> scoring region, “2” for a <Body> scoring region, and “3” for a <meta> scoring region. Similarly, FIG. 6B illustrates a one-dimensional array that is indexed by word location and returns a “0” for a default weight region, a “1” for a boldface (<b>) weight region, and a “2” for a heading 1 (<h1>) weight region. Referring back to FIG. 5, block 530 is illustrated in dotted lines to illustrate that it is optional.

At block 540, the query execution module begins accepting queries. When a query is received, the query execution module first parses the query 550. The parsed query is then executed 560 to obtain a result. Then, the query execution module calculates a relevance ranking score for each document using the administrator-defined relevance ranking parameters 570. Finally, the query execution module returns a result to the entity that requested the query 580.

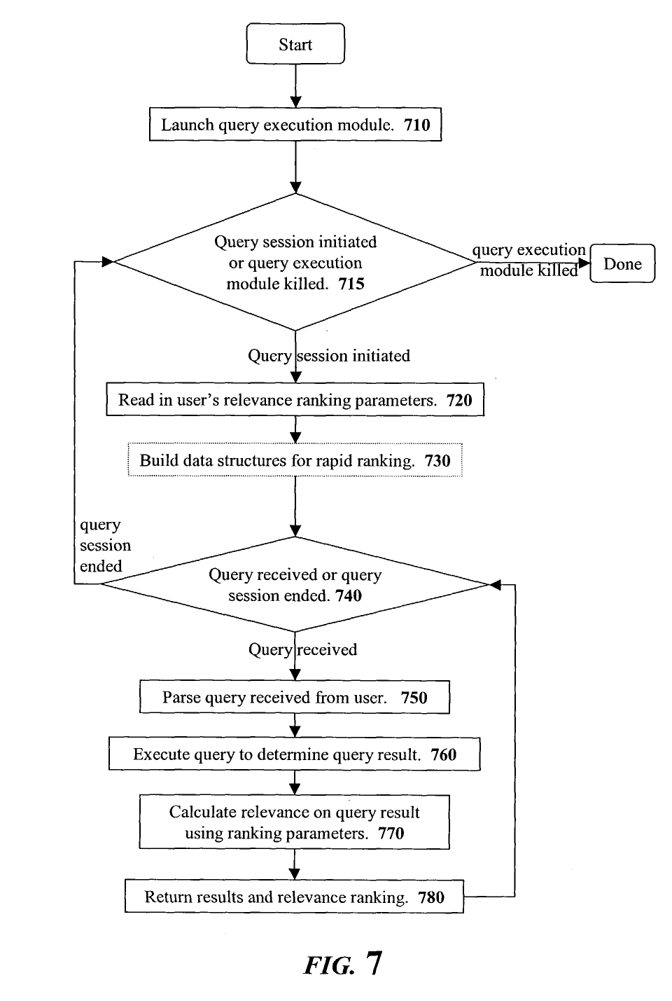

FIG. 7 illustrates an alternate embodiment that allows relevance ranking parameters to be configured on a session basis. In this manner, a user that wishes to have a personal relevance ranking system may create such a custom relevance ranking system for a specific searching session.

Referring to FIG. 7, the system starts by launching the query execution module 710. The query execution module waits to be terminated or for a user to initiate a query session 715. When a user initiates a query, the query execution module reads in the user's relevance ranking parameters 720. The user's relevance ranking parameters may be provided as arguments when initiating the query session, in a configuration file, or in another other suitable manner.

After reading in the user's relevance ranking parameters, the system creates data structures for rapidly calculating relevance scores 730. For example, the query execution module may generate one-dimensional arrays, such as those illustrated in FIGS. 6A and 6B, for determining scoring regions and adjusted weight sections, respectively.

The query execution module is then prepared to accept queries from the user 740. If the user terminates the query session, the query execution module returns to 715 and waits for termination or another query session to be initiated. When a query is received, the query execution module 140 parses the query 750. Next, the query execution module executes the query 760 to determine a resultant set of documents.

The query execution module 140 calculates a relevance score using ranking parameters 770. Finally, the query execution module 140 returns the list of resultant documents along with their respective relevance ranking scores 780.

The foregoing has described a document region sensitive configurable relevance ranking system. It is contemplated that changes and modifications may be made by one of ordinary skill in the art, to the materials and arrangements of elements of the present invention without departing from the scope of the invention.

1. A method of ranking results from a free-text query of a document repository, comprising:
generating a set of relevance ranking parameters characterizing document areas in text documents of a document repository;
producing results from a free-text query of said document repository; and
ranking said results in accordance with said relevance ranking parameters.

2. The method of claim 1 wherein generating includes defining a scoring region.

3. The method of claim 2 wherein generating includes defining a scoring region in a semi-structured text document.

4. The method of claim 3 wherein generating includes defining a scoring region as a tag delimited region of an XML document.

5. The method of claim 1 wherein generating includes generating a proximity score relevance ranking parameter that characterizes word distance between matching search terms.

6. The method of claim 5 wherein generating includes generating a harmonic mean proximity score relevance ranking parameter.

7. The method of claim 1 wherein generating includes generating a matching term frequency score relevance ranking parameter characterizing the number of times a specified search term appears in a document.

8. The method of claim 7 wherein generating includes generating an absolute frequency matching term frequency score.

9. The method of claim 7 wherein generating includes generating a relative frequency matching term frequency score.

10. The method of claim 7 wherein generating includes generating a normalized frequency matching frequency score.

11. The method of claim 1 wherein generating includes generating relevance ranking parameters in accordance with adjusted weight criteria.

12. The method of claim 1 wherein producing includes performing a free-text query against a word index specifying word locations in documents of said document repository.

13. A computer readable medium, comprising:
executable instructions to:
generate a set of relevance ranking parameters characterizing document areas in
text documents of a document repository;
produce results from a free-text query of said document repository; and
rank said results in accordance with said relevance ranking parameters.

14. The computer readable medium of claim 13 wherein said executable instructions to generate a set of relevance ranking parameters include executable instructions to define a scoring region.

15. The computer readable medium of claim 14 wherein said executable instructions to generate a set of relevance ranking parameters include executable instructions to define a scoring region in a semi-structured text document.

16. The computer readable medium of claim 15 wherein said executable instructions to generate a set of relevance ranking parameters include executable instructions to define a scoring region as a tag delimited region of an XML document.

17. The computer readable medium of claim 13 wherein said executable instructions to generate a set of relevance ranking parameters include executable instructions to generate a proximity score relevance ranking parameter that characterizes word distance between matching search terms.

18. The computer readable medium of claim 17 wherein said executable instructions to generate a set of relevance ranking parameters include executable instructions to generate a harmonic mean proximity score relevance ranking parameter.

19. The computer readable medium of claim 13 wherein said executable instructions to generate a set of relevance ranking parameters include executable instructions to generate a matching term frequency score relevance ranking parameter characterizing the number of times a specified search term appears in a document.

20. The computer readable medium of claim 19 wherein said executable instructions to generate a set of relevance ranking parameters include executable instructions to generate an absolute frequency matching term frequency score.

21. The computer readable medium of claim 13 wherein said executable instructions to generate a set of relevance ranking parameters include executable instructions to generate a relative frequency matching term frequency score.

22. The computer readable medium of claim 13 wherein said executable instructions to generate a set of relevance ranking parameters include executable instructions to generate a normalized frequency matching frequency score.

23. The computer readable medium of claim 13 wherein said executable instructions to generate a set of relevance ranking parameters include executable instructions to generate relevance ranking parameters in accordance with adjusted weight criteria.

24. The computer readable medium of claim 13 wherein said executable instructions to rank said results include executable instructions to perform a free-text query against a word index specifying word locations in documents of said document repository.
